(19) United States
(12) Patent Application Publication
(10) Pub. No.: US 2025/0284118 A1
(43) Pub. Date: Sep. 11, 2025

(54) MEMS Actuation

(71) Applicant: Maradin Ltd., Yoqne'am Ilit (IL)

(72) Inventors: Gil CAHANA, Herzelia (IL); Ran GABAI, Haifa (IL); Adi BARAM, Yoqneam (IL); Matan NAFTALI, Moshav Aloney-Aba (IL)

(21) Appl. No.: 19/070,005

(22) Filed: Mar. 4, 2025

Related U.S. Application Data
(60) Provisional application No. 63/561,505, filed on Mar. 5, 2024.

(51) Int. Cl. G02B 26/08; H02N 1/00

(52) U.S. Cl. CPC G02B 26/085; H02N 1/008

(57) ABSTRACT

Microelectromechanical electrostatic actuator apparatus configured to be driven by an attractive aka pulling electrostatic force between electrically isolated electrically conductive elements, to generate motion, the elements comprising: at least three stators fixed to a substrate such as a MEMS handle layer, and (at least one) movable rotor which may be connected to a compliant suspension or spring structure and wherein driving voltage introduces electrical potential difference between the stators and/or rotor to yield the attractive electrostatic force which generates the motion by displacing the rotor toward the stator/s.

### FIELD

The present invention is related to the field of MEMS devices in general and electro-static actuation thereof in particular.

### BACKGROUND

MEMS applications, which require tilting motion of reflecting surfaces (i.e., micro-mirrors), are known. Use of electro-static actuation, e.g., for wearable applications, is known.

Comb-drive structures for use as electro-static actuators are known.

Angular vertical comb-drive actuators for scanning micromirrors are known, and are described e.g., in Dooyoung Hah et al, “Theory and Experiments of Angular Vertical Comb-Drive Actuators for Scanning Micromirrors” available online at nanophotonics.eecs.berkeley.edu/Publications/Journal/files/563/Hah % 20et%20al.%20-% 202004%20-%20Theory%20and%20experiments%20of%20angular%20vertical%20comb-dr.pdf.

The disclosures of all publications and patent documents mentioned in the specification, and of the publications and patent documents cited therein directly or indirectly, are hereby incorporated herein by reference in their entirety. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments seek to provide a comb-drive architecture, either vertical or horizontal, having flexibility to control shape and/or speed and/or form of a rotor's motion.

Certain embodiments seek to provide all or any subset of the following:
a. A vertical comb-drive which provides rotational motion. Typically, the vertical comb drive herein produces rotational motion with less power than is conventional and/or produces rotation with a greater travel range or amplitude using the same power as is conventional.
b. A horizontal comb-drive which produces translation, e.g., of a rotor, e.g. in the direction of the arrow as shown. Typically, the horizontal comb drive herein produces translation with less power than is conventional and/or produces rotation with a greater travel range or amplitude using the same power as is conventional.
c. A horizontal comb drive with the flexibility to control the shape and/or velocity and/or form of a rotor's motion.
d. A vertical comb drive with the flexibility to control the shape and/or velocity and/or form of the rotor's motion.
e. An improved method and system for electro-static actuation of rotating/tilting MEMS devices and/or MEMS devices which travel in-plane.
f. A new electro-static actuation scheme, control, and architecture of MEMS devices including rotating elements which generates larger actuation forces and seamless motion and/or which enables a simple implementation and sufficient power for high quality performances typically required in, say, rotating MEMS devices.
g. A scanning mirror actuated by a vertical comb-drive or horizontal comb-drive comprising a 4 silicon elements comb-drive structure, with electrical isolation between each two elements.
h. An electrostatic comb drive which includes at least one rotor providing movable fingers, and at least one stator providing stationary fingers.
i. A MEMS device with a comb-drive actuator comprising at least 4 silicon elements, each pair of which is isolated electrically between them, the silicon elements being deployed either vertically, e.g., as a stack, or horizontally, either as a vertical comb-drive, or as an in-plane comb-drive.
j. An improved horizontal comb drive in which the electrostatic force vector applied to the moving element (e.g. rotor) lies within the XY (aka horizontal) plane. A rotor having only rotational degrees of freedom may generate yaw motion in the XY plane, for example.
k. An improved vertical comb-drive in which the electrostatic force vector applied to the moving element (e.g., rotor) lies within a vertical (e.g., XZ or YZ) plane. If the rotor has only rotational degrees of freedom, this force vector may yield tilting movement or rotational motion with a Z component displacement, in which case a portion of the mirror may depart from the XY plane. If the rotor has only translation of degrees of freedom, the resulting up-down motion may be a piston-like motion in the XZ plane or YZ plane.
l. An improved electro-static actuator (e.g., comb-drive) in which the rotor has only rotational degrees of freedom such that the electrostatic force vector applied to the moving element (e.g., rotor) yields tilting or rotational motion.
m. An improved method, architecture, and control scheme for electro-static actuation of rotating MEMS devices.
n. A vertical comb drive comprising a stack of layers, wherein a single layer includes both moving and fixed fingers in addition to fingers above and/or below the fixed fingers which are not in the same layer.
o. A vertical comb-drive with 4 (or more) comb-sets constructed or deployed within less than 4 MEMS structural layers, e.g., stators in top, bottom, and middle layers providing fixed fingers, and a rotor providing moving fingers in one of the same layers, e.g., in the middle layer. Typically, the first group of moving comb sets each have N fingers, and the second group of stationary or fixed comb sets each have N or N+1 or N−1 fingers.
p. A horizontal ES actuator comprising at least 4 electrostatic actuators, e.g., conductive e.g., silicon elements, at least some deployed or constructed one aside another, e.g., in a single MEMS layer, at least some pairs of which are isolated electrically between them.
q. A vertical ES actuator including stators and rotors in different layers and also in the same layer.
r. A horizontal ES actuator including stator/s and rotor/s in same layer, typically able to be electrically isolated from one another, and, optionally, additional stators in other layers, typically able to be electrically isolated from the rotor/s and other stator/s.
s. A moving rotor that has stator elements around it, from both its sides in the direction of the motion. All of these stator elements are typically electrically isolated from one another and could be electrically connected in different ways to apply both translation and rotation motion of the rotor.
t. A horizontal ES actuator comprising a moving rotor that has stator elements on both sides, and also may have stator elements in front of or in back of the rotor (relative to the direction of the movement).

The term “layer” herein may refer to a MEMS layer, e.g., as described here: www.researchgate.net/figure/Metal-MEMS-fabrication-process-The-formation-of-each-layer-involves-three-steps-a_fig3_221732940.

The present invention typically includes at least the following embodiments:

Embodiment 1. Microelectromechanical electrostatic actuator apparatus configured to be driven by an attractive aka pulling electrostatic force acting between electrically isolated electrically conductive elements, thereby to generate motion, the electrically isolated electrically conductive elements comprising: at least three stators (e.g., if tilting motion rather than linear motion is to be provided) fixed to a substrate such as a MEMS handle layer, and/or (at least one) movable rotor (e.g. if tilting motion rather than linear motion is to be provided) which may be connected to a compliant suspension or spring structure and wherein driving voltage typically introduces electrical potential difference between the stators and/or rotor e.g. to yield the attractive electrostatic force which may generate the motion by displacing the movable rotor toward the stator/s.

Embodiment 2. The apparatus according to any of the preceding embodiments and also comprising driving electronics circuitry to apply the driving voltage.

Embodiment 3. The apparatus according to any of the preceding embodiments and also comprising controlling electronics circuitry to control the driving electronics circuit.

Embodiment 4. The apparatus according to any of the preceding embodiments wherein the controlling electronics circuitry controls the driving electronics circuitry to apply first and second different electrical potentials to at least first and second ones from among the electrically isolated electrically conductive elements.

Embodiment 5. The apparatus according to any of the preceding embodiments and wherein the rotor comprises a moving MEMS element, to be driven by the attractive electrostatic force. Typically the mirror comprises a plate that reflects light in different tilting positions and is included in the rotor.

Embodiment 6. The apparatus according to any of the preceding embodiments and also comprising a product, such as a laser beam scanning display for a wearable e.g., smart glasses, wherein the moving element, e.g., tilting mirror, is employed to provide the product's scanning functionality.

Embodiment 7. The apparatus according to any of the preceding embodiments wherein the moving MEMS element comprises a rotating/tilting MEMS element (e.g., a mirror (e.g., scanning mirror, tilting mirror).

Embodiment 8. The apparatus according to any of the preceding embodiments wherein the MEMS element/s are driven to travel in-plane.

Embodiment 9. The apparatus according to any of the preceding embodiments which creates plural forms of motion as a function of voltage patterns applied to the rotor/s and stator/s.

Embodiment 10. The apparatus according to any of the preceding embodiments wherein the plural forms of motion include all or any subset of: linear motion, step motion, sinusoidal motion.

Embodiment 11. The apparatus according to any of the preceding embodiments wherein the electrically isolated electrically conductive elements comprise comb sets defining fingers, and wherein the stators comprise fixed comb sets, thereby to provide at least three respective arrays or sets of (say, 70, although this value is used throughout merely by way of example) fixed fingers each.

Embodiment 12. The apparatus according to any of the preceding embodiments wherein the rotor comprises a comb set, thus providing movable fingers.

Embodiment 13. The apparatus according to any of the preceding embodiments wherein the stators and rotor/s are arranged in a stack of at least three layers and wherein both a stator and a rotor reside together in one of the layers, thereby to define an improved vertical electrostatic actuator.

Embodiment 14. A microelectromechanical electrostatic actuation method wherein an attractive, aka pulling electrostatic force, acts between electrically isolated electrically conductive elements, thereby to generate motion wherein the electrically isolated electrically conductive elements may comprise: at least three stators (e.g., if tilting motion rather than linear motion is to be provided) fixed to a substrate such as a MEMS handle layer, and/or (at least one) movable rotor (e.g. if tilting motion rather than linear motion is to be provided) which may be connected to a compliant suspension or spring structure and wherein driving voltage typically introduces electrical potential difference between the stators and/or rotor e.g. to yield the attractive electrostatic force which generates the motion by displacing the movable rotor toward the stator/s.

Embodiment 15. The method of any of the preceding embodiments wherein at least one stator and the rotor are constructed within a single layer and are typically electrically isolated from one another.

Embodiment 16. The method of any of the preceding embodiments wherein additional stator/s are deployed or constructed or arranged above and/or below the single layer, typically electrically isolated from the rotor and typically electrically isolated from at least one other stator (typically from all of the other stator/s).

Embodiment 17. The apparatus according to any of the preceding embodiments wherein the stator and the rotor which reside together, reside in/are constructed within a middle layer, which is below a top layer in which at least one of the stators resides/is constructed and above a bottom layer in which at least one of the stators resides/is constructed, thereby to define top, middle, and bottom stators.

Embodiment 18. The apparatus according to any of the preceding embodiments wherein at least one of the stators includes right and left electrically isolated elements.

Embodiment 19. The apparatus according to any of the preceding embodiments wherein each of the top, middle, and bottom stators each include right and left stator elements electrically isolated from one another thereby to define six elements all electrically isolated from one another, except that the top stator's right stator element is electrically connected to the bottom stator's left stator element, and/or the top stator's left stator element is electrically connected to the bottom stator's right stator element, and/or the middle stator's right and left stator elements are electrically connected.

Embodiment 20. The apparatus according to any of the preceding embodiments wherein the apparatus is used as a vertical electrostatic actuator with rotational motion.

Embodiment 21. The apparatus according to any of the preceding embodiments wherein each of the top, middle, and bottom stators each include right and left stator elements electrically isolated from one another thereby to define six elements, all electrically isolated from one another, except that:

the top stator's right stator element is electrically connected to the bottom stator's left stator element, and/or

the top stator's left stator element is electrically connected to the bottom stator's right stator element, and/or

the top stator's right stator element is electrically connected to the top stator's left stator element, and/or

the middle stator's right and left stator elements are electrically connected, and/or

the bottom stator's right stator element is electrically connected to the bottom stator's left stator element,
wherein the apparatus may be used as a vertical electrostatic actuator with up-down or translation motion.

Embodiment 22. The apparatus according to any of the preceding embodiments wherein each of the top, middle, and bottom stators each include right and left stator elements electrically isolated from one another thereby to define six elements, all electrically isolated from one another, except that:

the top stator's right and left stator elements are electrically connected and/or

the middle stator's right and left stator elements are electrically connected and/or

the bottom stator's right and left stator elements are electrically connected and wherein the apparatus is used as a horizontal electrostatic actuator.

Typically, for horizontal electrostatic stators, stator elements are electrically isolated from one another except for stator couples that are opposite one another in a given layer (top and/or middle and/or bottom) which are electrically connected.

Typically, for vertical electrostatic stators used for rotation, top stator elements are electrically isolated from one another, bottom stator elements are electrically isolated from one another, middle stator elements are connected, and stator elements in the top and bottom layers are connected crosswise (left top to right bottom and right top to left bottom).

Typically, for vertical electrostatic stators used for translation, stator couples that are opposite one another in a given layer (top and/or middle and/or bottom) are electrically connected and stator elements in the top and bottom layers are connected crosswise (left top to right bottom and right top to left bottom).

Embodiment 23. The apparatus according to any of the preceding embodiments wherein the rotor has a direction of movement and wherein stators from among the at least three stators are arranged on both sides of the direction of movement and wherein the at least three stators are electrically isolated from one another and typically from the rotor.

Embodiment 24. The apparatus according to any of the preceding embodiments wherein the stators can be electrically connected to yield rotor translation e.g. in the direction of the arrow as shown.

Embodiment 25. The apparatus according to any of the preceding embodiments wherein the stators can be electrically connected to yield rotor rotation.

Embodiment 26. The apparatus according to any of the preceding embodiments wherein the electrical connections are per use.

Embodiment 27. The apparatus according to any of the preceding embodiments wherein the stators can be electrically connected in different ways to yield, e.g., selectably, both translation and rotation of the rotor.

Embodiment 28. For the vertical case with rotational motion, typically, the top stator has right and left elements, same for the middle and bottom stators, and all of these six elements are electrically isolated from one another except that the top stator's right element is electrically connected to the bottom stator's left element, the top stator's left element is electrically connected to the bottom stator's right element, and the middle stators right and left elements are electrically connected.

For up-down motion (not rotational) in the vertical case, the stator elements are also connected top right to top left and bottom right to bottom left.

For the horizontal case, electrical connection is typically in couples opposite one another i.e. left-right e.g., in the same layer, and not in cross to one another with isolation between right in one layer and left in another layer (e.g., right top vs. left bottom or right bottom vs left top). It is appreciated that electrically isolated elements (say, the top stator's right and left elements) may or may not mechancially be a single piece. For example, if the isolated elements are separated by an air gap, they are mechanically separate pieces. However, if isolation between elements is provided by using solid isolation materials such as oxide or nitride rather than air, the elements form a single mechanical piece having 2 different electrical areas.

The embodiments referred to above, and other embodiments, are described in detail in the next section.

Any trademark occurring in the text or drawings is the property of its owner, and occurs herein merely to explain or illustrate one example of how an embodiment of the invention may be implemented.

Elements separately listed herein need not be distinct components, and alternatively may be the same structure. A statement that an element or feature may exist is intended to include (a) embodiments in which the element or feature exists; (b) embodiments in which the element or feature does not exist; and (c) embodiments in which the element or feature exist selectably, e.g., a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface, or other system illustrated or described herein. Any suitable computerized data storage, e.g., computer memory may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s, e.g., as described herein, which may, for example, include all or any subset of an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof, and back-end logic interacting therewith. Thus, the term user interface or “UI” as used herein, includes also the underlying logic which controls the data presented to the user, e.g., by the system display, and receives and processes and/or provides to other modules herein, data entered by a user, e.g., using her or his workstation/device.

### BRIEF DESCRIPTION OF THE DRAWINGS

Example embodiments are illustrated in the various drawings. Specifically:

FIG. 1A shows an Isometric view of MEMS device which may include a 3-layer electro-static vertical comb-drive actuator. The apparatus of FIGS. 1a-1d is an example of a vertical actuator or vertical comb-drive which creates rotational motion of the moving element, e.g., mirror, which has a component that moves in the Z direction.

FIG. 1B shows a cross-section (perpendicular; A-A as indicated) of the comb-drive of FIG. 1a.

FIG. 1C shows a cross-section A-A of the comb-drive of FIG. 1a as rotated.

FIG. 1D shows a cross-section (perpendicular; B-B as indicated) of the comb-drive of FIG. 1a as rotated.

FIG. 2 shows a time chart of the electro-static actuation method for a resonating vertical comb-drive, e.g., the comb-drive of FIGS. 1a-1d. As shown in FIG. 2 (for Sine waveform oscillations), alternating potential differences may be applied between the stator elements and the rotor; these alternating potentials are designed to yield electrostatic force generated in a desired form (e.g. step, ramp, Sine).

FIG. 3 shows example driving parameter computations.

FIG. 4 shows a (prior art) comb drive actuator.

FIG. 5A shows an isometric view of horizontal AKA “in-plane” actuator.

FIG. 5B shows a cross-section C-C of the horizontal aka “in-plane” actuator of FIG. 5a.

FIG. 5C shows a cross-section D-D of the horizontal aka “in-plane” actuator of FIG. 5b.

FIG. 6 is a generalized circuit block diagram according to certain embodiments showing control of a MEMS comb drive.

### DETAILED DESCRIPTION

It is appreciated that references to tilting motion herein are merely by way of example and may be replaced by references to motion of other types mentioned herein. Also, references to comb-drives herein are merely by way of example, and may be replaced by references to electro-static actuators generally.

Electro-static actuation generates motion by applying pulling electro-static forces between two of a MEMS device's structural elements, one of which is a rotor which has the ability to move, e.g. (if the rotor is a rotating mirror) either in plane (in the XY plane defined by the rotating mirror's main surface) or out of plane, in which case the motion generated by the electro-static actuation also includes a Z component or component perpendicular to the rotating mirror's main surface (e.g., micro-mirror's surface element).

As shown in FIG. 6, certain embodiments include all or any subset of:

a) A MEMS device 180 within a product, whose motion, e.g., rotation, is to be actuated and controlled, having four different electrically conductive (e.g. silicon) elements isolated electrically pairwise (e.g., via gap of air or of isolating material such as Oxide, Nitride etc.), that may, for example, be formed either vertically (as vertical comb-drive), or horizontally (as in-plane comb-drive).
b) Driving electronics circuit 150
c) Controlling electronics circuit 160
d) Sensing circuitry 170 providing sensed parameters such as rotor's position with respect to the stators, to the control circuitry.

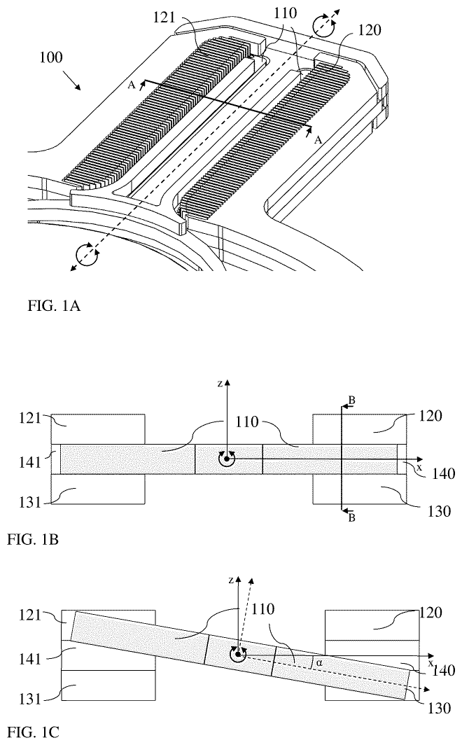

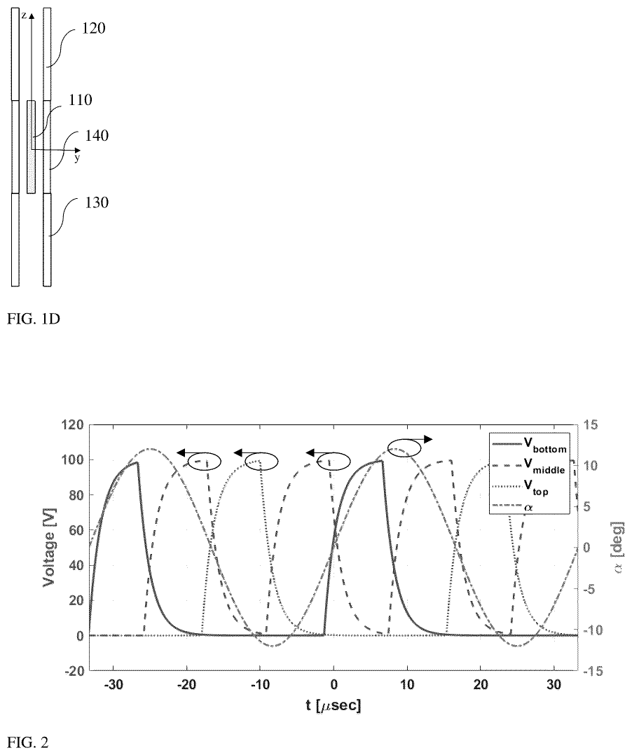

The four elements typically include a three comb-drive structure e.g., as shown in FIG. 1a for vertical use, including three stationary elements (i.e., top, bottom, and middle stators 120, 130, 140 e.g., for a tilting motion) and a moving mid-element (e.g., rotor for a tilting motion e.g. as shown in gray). Motion of the mid-element may be generated by applying different electrical potentials to the conductive, e.g., silicon elements, yielding electro-static actuation. The top and bottom stators may optionally be electrically connected.

The sequence of the electrical potentials applied to the elements is determined by the driving electronics circuit (e.g. as shown in FIG. 2 for a vertical comb-drive resonating actuation).

The sequence typically is designed to generate continuous motion of the mid-element, and/or to maximize its travel trajectory, e.g., traveling amplitude.

Generally, in horizontal comb-drive actuators, the ES (electrostatic) force works on the moving element (rotor) within the XY plane (i.e., horizontally). In contrast, in vertical comb-drive actuators, the ES force works on the moving element (rotor) within the XZ or YZ plane (i.e., vertically). When the rotor has only rotational degree of freedom, tilting motion may result, and portion/s of the mirror typically depart from the XY plane (have a Z component displacement). FIG. 1A shows an isometric view of a MEMS device which may include a three-layer electro-static vertical comb-drive actuator. FIG. 1B shows a cross-section (perpendicular; A-A as indicated) of the comb-drive of FIG. 1a. FIG. 1C shows a cross-section A-A of the comb-drive of FIG. 1a as rotated. FIG. 1D shows a cross-section (perpendicular; B-B as indicated) of the comb-drive of FIG. 1a as rotated. Note body of rotor, in gray.

The rotated elements included in the MEMS device 100 of FIGS. 1a-1d may include all or any subset of rotor element 110, stator top-left element 120, stator top-right element 121, stator bottom-left element 130, stator bottom-right element 131, stator middle-left element 140, and stator middle-right element 141. Typically, the electrical connection scheme is diagonal such that elements 120+131 are electrically connected and/or elements 130+121 are electrically connected, and/or elements 140+141 are electrically connected.
Numerical example (X actuator aka vertical actuator; electrostatic comb drive around the X axis):

MEMS Comb drive includes 3 stator layers including top and bottom layers which may be 40 [um] each.

Each of the top and bottom comb-set may comprise plural fingers such as, say, 70 fingers, each 125 [um] long 3.5 [um] wide with 3.25 [um] gap between them.

Middle layer comb fingers may be 3 [um] wide with 3.5 [um] gaps between them.

Comb resonance may be >300 [kHz].

Comb-set is built on a structural element or wing whose resonance exceeds 100 [kHz].
Typically:

Comb end deflection due to misalignment of 1.2 [um] and 150[V]−<|[um].

Diameter [mm_2] 1.1×1.0,

X Inertia [kg*mA2 E-15] 5.5,

FOV @ Q=200 is [Deg] 43.1

FIG. 1B is a snapshot of a device in its resting (zero) position where the device's motion is linear (up and down) rather than tilting motion.

FIGS. 1c, 1d are respective snapshots of tilting motion (not necessarily sinusoidal), at a resting (zero) position and maximally tilted position, respectively.

It is appreciated that finger sets in different MEMS layers may or may not be electrically isolated; finger sets may be electrically connected, even if in different layers.

Reference is now made to FIG. 2 which is a voltage/torque graph showing pulses generated during electro-static actuation using potential pulses to oscillate a micro-mirror at its resonance frequency, e.g., in conjunction with the apparatus of FIGS. 1a-1d.

In order to maintain maximal travel, the driving parameters may be controlled or optimized using a controlling electronics circuit. The time chart of example driving parameters, all or any subset of which may be employed, as shown in FIG. 2, is merely exemplary. The angle (y-axis, right-hand legend), whose values over time are shown in dash-dotted line, may comprise angle alpha in FIG. 1c. As indicated in the legend, solid, dashed, and dotted lines are used to indicate voltage over time for the bottom, middle, and top stators respectively. The four ellipses with arrows indicate, for the three arrows pointing left, three respective graphs pertaining to the left vertical axis, and for the one arrow pointing right, a graph pertaining to the right vertical axis.

The angle in the time-chart of FIG. 2 is the tilting angle or mirror travel trajectory, in the special case of tilting sinusoidal/resonance motion of a rotating mirror. The angle is representative of the mirror's angular position, and may be defined between the element e.g., mirror driven by the comb drive, and the horizontal plane. The angle may be defined between the xy and z component of the mirror's motion.

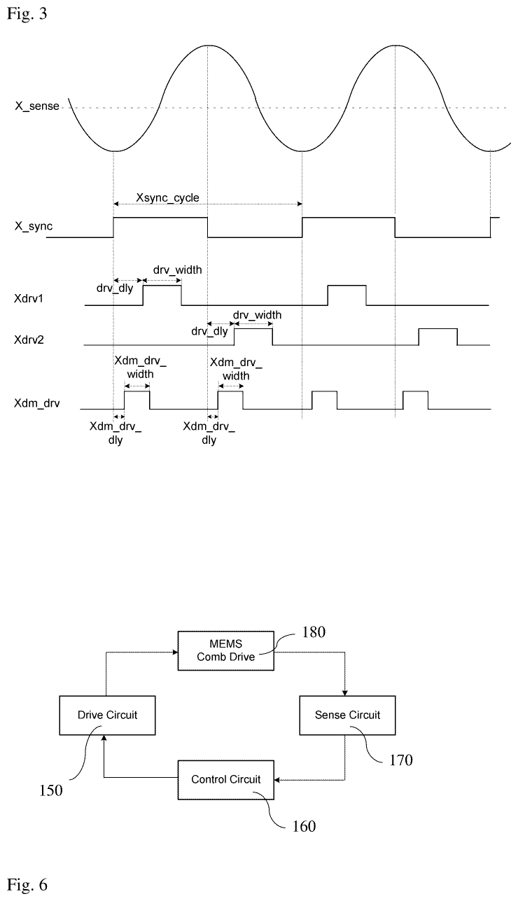

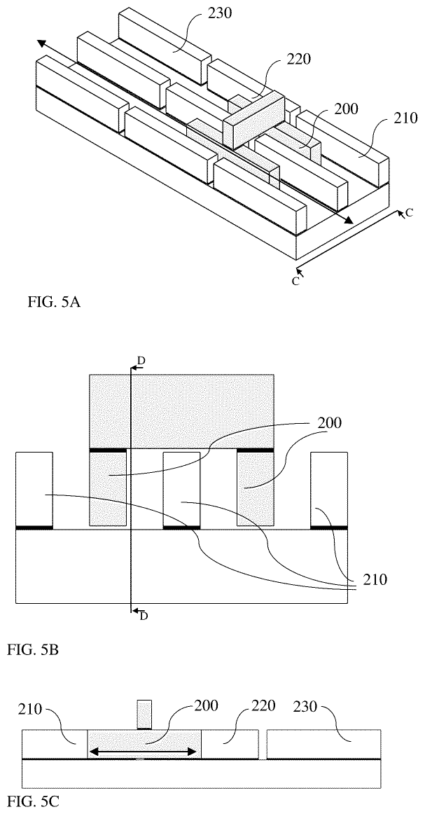

FIG. 3 shows an example timing diagram of driving signals which may be used to drive the rotor, e.g., of FIGS. 1a-1d or of FIGS. 5a-5c; note body of rotor in gray.

Signals may include all or any subset of:

X_sense—represents the (instantaneous) position of the rotor over time.
X_sync—digital signal that is synchronized to the X_sense with its phase aligned to the peaks of the
X_sense signal. This may be the source for the synchronization of the driving potentials in order to move the rotor.
Xdrv1, Xdrv2—driving signals of the top and bottom comb drive elements respectively.
Xdm_drv-driving signal of the middle comb drive element.

Driving Parameters may include all or any subset of:

Xsync_cycle—time period of the rotor sinusoidal motion.
drv_dly—A drive delay or time delay between the top and bottom driving signals to the X_sync signal.
drv_width—The time the driving signals of the top and bottom comb drives are enabled.
Xdm_drv_dly—A time delay between the middle driving signals to the X_sync signal.
Xdm_drv_width—The time the driving signal of the middle comb drive is enabled. Typically:
drv_dly=drv_phase*Xsync_cycle/2
drv_width=drv_width phase*Xsync_cycle/2

Example values:

drv_phase: 0.12 (0/4096 . . . 4095/4096)
drv_width_phase: 0.12 (0/4096 . . . 4095/4096)

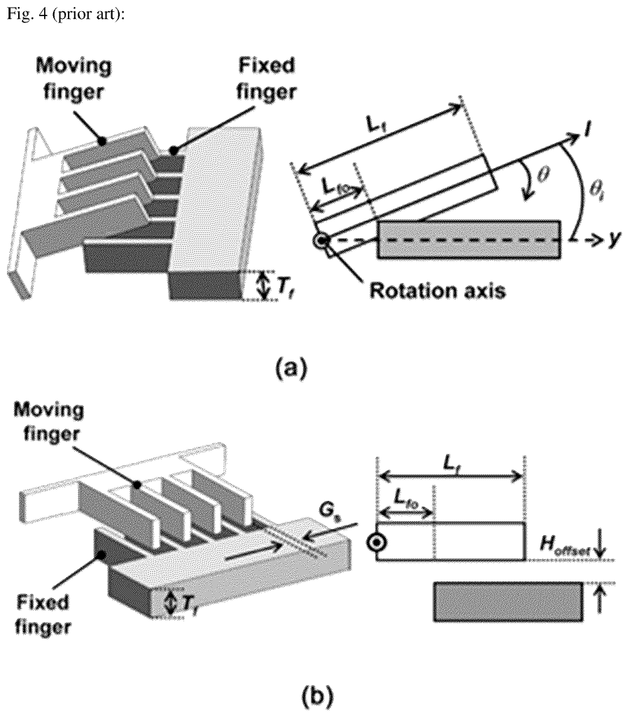

FIG. 4 shows a (prior art) comb drive actuator.

FIG. 5A shows an Isometric view of a horizontal aka “in-plane” actuator.

FIG. 5B shows a cross-section C-C of the horizontal aka “in-plane” actuator of FIG. 5a.

FIG. 5C shows a cross-section D-D of the horizontal aka “in-plane” actuator of FIG. 5b.

The horizontal elements included in the horizontal embodiment of FIGS. 5a-5c may include all or any subset of plural rows of rotor elements 200 typically interspersed between rows of stator elements, where each row in the illustrated embodiment includes stators 210, 220, and 230, and each row of rotor elements comprises a single rotor 200. The illustrated embodiment includes but a single column of rotor elements typically with single voltage (e.g., typically all rotor elements aka rotors 200 are deployed or arranged in a single column, and typically all have the same electrical potential).

There are plural (e.g. three) columns of stator elements; in the illustrated embodiment, 3 columns are shown, the first including stators 210, the second including stators 220, the third including stators 230. Typically, all stators in a given column are electrically connected, and, typically, all rotors in a given column are electrically connected.

It is appreciated that here and/or elsewhere, each rotor element may serve as a basic unit cell of a single rotor located between stator elements, e.g., if electrically isolated from other elements (other unit cells), or multiple unit cells may be electrically connected, thereby to provide flexibility in terms of what rotor motion is produced.

Typically, the bottom base (formed, say, of silicon or glass) holds or supports all stator elements which are typically fixed thereupon and which are isolated from one another by (say) an air gap and from the base by (say) an oxide or nitride layer.

The rotors connection bar, shown by way of example above the rows and columns (shown atop element 200 by way of example), is an example of how plural rotor elements may be electrically connected to one another, via (typically electrically conductive e.g. silicon) bar/s. It is appreciated that here and elsewhere, stator elements and rotor elements which may be all shown to be the same size, need not in fact all be the same size.

Typically, all rotors in the (single) column of rotors all have the same potential.

The voltages of the rotors in each of the (three, e.g.) columns depends on what motion is desired and what type of control is desired, using any known electrostatic actuation control methods.

Typically, as shown, each column is electrically connected, thus all rotors in the column are electrically connected to one another, and all stators included in a given column are electrically connected to one another, but electrically isolated from all stators in all other columns, and from all rotors.

The apparatus of FIGS. 5a-5b is an example of a horizontal actuator or horizontal comb-drive which typically creates horizontal motion of the moving element, e.g., mirror.

The scope of the invention includes a horizontal comb-drive which creates plural forms of motion as a function of voltage patterns applied to the rotor/s and stator/s wherein the plural forms of motion include all or any subset of linear motion, step motion, and sinusoidal motion. The scope of the invention also includes a vertical comb-drive which creates plural forms of motion as a function of voltage patterns applied to the rotor/s and stator/s, wherein the plural forms of motion include all or any subset of linear motion, step motion, and sinusoidal motion.

Typically, alternating potential differences are applied between the stator elements and rotor to generate ES (electrostatic) force in plural desired, e.g., selectable forms of rotor motion (e.g. step and/or ramp and/or sine-shaped rotor motion). As an example, for a horizontal comb-drive such as but not limited to that shown in FIGS. 5a-5c, a graduated or gradual or gradated shift of the potential difference between two sets of stator elements may be provided that increases (e.g., S1 then S2 then S3, and pulls the rotor to the same direction, and will yield a graduated or gradual or gradated motion of the rotor.

If it is desired to use a vertical electrostatic comb drive (such as but not limited to the comb-drive of FIGS. 1a-1d) to generate various forms of motion, the following may be provided:

a. for upward-piston motion of the MEMS device (e.g., mirror moving up), the top and middle stator elements (i.e., comb-drives) may be operated simultaneously, creating potential difference (e.g. from each of them) to the rotor.

b. for downward-piston motion of the MEMS device, the bottom rather than top stator elements may be operated in the same manner e.g., to cause the mirror (say) to move down. The bottom and middle stator elements (e.g. comb-drives) may be operated simultaneously, creating potential difference to the rotor.

c. for upward-step motion of the MEMS device (e.g., mirror moving up and stops), only the top (right and left e.g.) stator elements (e.g. comb-drives) may be operated simultaneously, creating potential difference to the rotor.

d. for downward-step motion, the bottom rather than top stator elements may be operated in the same manner e.g., to cause the mirror (say) to move down then stop, only the bottom stator elements (e.g., comb-drives) may be operated simultaneously (e.g. provide control signal to both at same time), creating potential difference to the rotor e.g., relative to the top stators.

e. for sine (sinusoidal) motion of the MEMS device (e.g., mirror moving up and down in a sine): the middle+top stator elements (e.g. comb-drives) may be operated simultaneously typically together with the middle and bottom stator elements of the opposite (e.g. left vs. right) sets, creating potential difference to the rotor, to be followed by only the top stator and opposite bottom elements (e.g. comb-drives) may be operated, and then only the middle stator elements (e.g., comb-drives) may be operated, and then the middle+bottom stator elements along with the opposite middle+top (e.g. comb-drives) may be operated simultaneously, and then, e.g., finally, only the bottom stator and the opposite top elements may be operated. It is appreciated that by way of example, the MEMS device may include an ES-actuator e.g. comb drive and a mirror driven by the actuator. However, more generally, the rotor need not be a mirror.

Many variations are possible. For example, the previous embodiments may be operated using different electrical potentials between each of two of the four (or more) silicon elements or each of three of the four (or more) silicon elements, e.g., different potentials may be applied to each of two of the three or more fixed comb sets or to each of the fixed comb sets.

The vertical apparatus of FIG. 1 (or a horizontal apparatus) may be operated at its resonance frequency typically using electrical potential pulses.

The middle of the three stator elements may actuate using pulses which are, say, double the frequency of the top stator element actuation pulses. Typically, the frequencies of the top and bottom stator element actuation pulses, are the same.

There may be different phases between the actuation pulses of each of, or some of, the three (or more) stator elements, such that each of (or some of) the three stator elements operate with a delay, relative to (some of) the two (or more) others.

The vertical apparatus of FIG. 1 (or a horizontal apparatus) may be operated using closed control, wherein at least one given phase shift is calibrated in advance and even if/when the main MEMS resonance changes e.g., due to heat, the phase shift remains constant e.g., as pre-calibrated. Typically, the three phase shifts for all three stator elements are calibrated in advance. During calibration, all phases may be moved together (usually digitally) until the expected result is obtained; the 3 phase shifts for all three stator elements may then be set accordingly.

The vertical apparatus of FIG. 1 (or a horizontal apparatus) may be operated without control such that if/when the main MEMS resonance changes e.g., due to heat, the phase shift changes, thus may increase or decrease.

The vertical apparatus of FIG. 1 (or a horizontal apparatus) may have a first control mode in which the comb-drive actuator is operated using closed control, and a second control mode in which the comb-drive actuator is operated without control.

Elements or characteristics of the apparatus herein may be combined with elements or characteristics of known comb-drive actuators such as but not limited that shown in prior art FIG. 4 which is excerpted from Dooyoung Hah et al, “Theory and Experiments of Angular Vertical Comb-Drive Actuators for Scanning Micromirrors” available online at

nanophotonics.eecs.berkeley.edu/Publications/Journal/files/563/Hah % 20et%20al.%20-% 202004%20-%20Theory%20and%20experiments%20of%20angular%20vertical%20comb-dr.pdf. It is appreciated that references to rotation, pivoting and tilt herein are merely by way of example, since applicability of embodiments herein is not limited to rotating/tilting mirrors and could, for example, also be used for devices moving or traveling in-plane, such as optical cross connect mirrors arrays (for rotating mirrors, the axis of rotation is in the XY plane, whereas in-plane motion occurs in the rotor's plane (e.g., XY plane). Out of plane motion includes a Z-component.

The apparatus and methods herein are advantageous for the many MEMS applications which require tilting motion of reflecting surfaces (i.e., micro-mirrors). Inter alia, the apparatus and methods herein are advantageous for applications having both a requirement for large tilting range and low power consumption. Electro-static actuation, e.g., as described herein, is particularly useful for use-cases where power consumption is important (e.g., wearable applications).

The electro-static actuation herein could be implemented both in cases where the required motion is in the rotor's plane and/or in rotating motion, in which the required motion is out of the rotor's plane.

Comb-drive structures e.g., as described herein, are particularly useful for electro-static actuation due to their actuation power per MEMS device area yielding good utilization.

For use-cases involving tilting motion, the vertical comb-drives herein may be particularly useful.

The apparatus and methods herein are advantageous for many products such as but not limited to—smart glasses, laser beam scanning (lbs) displays (e.g., smart glasses, HUD (heads up display), dynamic ground projection), and MEMS optical sensors (e.g., LIDAR).

Any hardware component mentioned herein may in fact include either one or more hardware devices e.g. chips, which may be co-located or remote from one another.

It is appreciated that terminology such as “mandatory”, “required”, “need” and “must” refer to implementation choices made within the context of a particular implementation or application described herewithin for clarity and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device, or distributed over several physical locations or physical devices. Any parameters described herein may be pre-set in the factory, or may be configured via an API, in the field, or may be configured by an end-user, via a suitable user interface.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis, e.g., triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein to have capabilities to perform a technical operation responsive to the state or condition. The technical operation may, for example, comprise changing the state or condition, or may more generally cause any outcome which is technically advantageous given the state or condition or data, and/or may prevent at least one outcome which is disadvantageous, given the state or condition or data. Alternatively, or in addition, an alert may be provided to an appropriate human operator or to an appropriate external system.

Features of the present invention, including operations which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly, although not limited to, those described in the Background section, or in publications mentioned therein.

Conversely, features of the invention, including operations, which are described for brevity in the context of a single embodiment or in a certain order, may be provided separately, or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered, e.g., as illustrated or described herein.

The terms processor or controller or module or logic as used herein are intended to include hardware such as computer microprocessors or hardware processors, which typically have digital memory and processing capacity, such as those available from, say Intel and Advanced Micro Devices (AMD). Any operation or functionality or computation or logic described herein may be implemented entirely or in any part on any suitable circuitry including any such computer microprocessor/s as well as in firmware or in hardware or any combination thereof.

It is appreciated that elements illustrated in more than one drawings, and/or elements in the written description may still be combined into a single embodiment, except if otherwise specifically clarified herewithin. Any of the systems shown and described herein may be used to implement or may be combined with, any of the operations or methods shown and described herein.

It is appreciated that any features, properties, logic, modules, blocks, operations or functionalities described herein which are, for clarity, described in the context of separate embodiments, may also be provided in combination in a single embodiment, except where the specification or general knowledge specifically indicates that certain teachings are mutually contradictory and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art. Each element e.g., operation described herein, may have all characteristics and attributes described or illustrated herein, or according to other embodiments, may have any subset of the characteristics or attributes described herein.

References herein to “said (or the) element x” having certain (e.g., functional or relational) limitations/characteristics, are not intended to imply that a single instance of element x is necessarily characterized by all the limitations/characteristics. Instead, “said (or the) element x” having certain (e.g. functional or relational) limitations/characteristics is intended to include both (a) an embodiment in which a single instance of element x is characterized by all of the limitations/characteristics and (b) embodiments in which plural instances of element x are provided, and each of the limitations/characteristics is satisfied by at least one instance of element x, but no single instance of element x satisfies all limitations/characteristics. For example, each time L limitations/characteristics are ascribed to “said” or “the” element X in the specification or claims (e.g. to “said processor” or “the processor”), this is intended to include an embodiment in which L instances of element X are provided, which respectively satisfy the L limitations/characteristics, each of the L instances of element X satisfying an individual one of the L limitations/characteristics. The plural instances of element x need not be identical. For example, if element x is a hardware processor, there may be different instances of x, each programmed for different functions and/or having different hardware configurations (e.g. there may be three instances of x: two Intel processors of different models, and one AMD processor).

1. Microelectromechanical electrostatic actuator apparatus configured to be driven by an attractive aka pulling electrostatic force acting between electrically isolated electrically conductive elements, thereby to generate motion, the electrically isolated electrically conductive elements comprising:
at least three stators (e.g., if tilting motion rather than linear motion is to be provided) fixed to a substrate such as a MEMS handle layer, and
(at least one) movable rotor (e.g. if tilting motion rather than linear motion is to be provided) which may be connected to a compliant suspension or spring structure
and wherein driving voltage introduces electrical potential difference between the stators and/or rotor to yield the attractive electrostatic force which generates said motion by displacing the movable rotor toward the stator/s.

2. The apparatus according to claim 1 and also comprising driving electronics circuitry to apply said driving voltage.

3. The apparatus according to claim 2 and also comprising controlling electronics circuitry to control said driving electronics circuit.

4. The apparatus according to claim 3 wherein said controlling electronics circuitry controls said driving electronics circuitry to apply first and second different electrical potentials to at least first and second ones from among said electrically isolated electrically conductive elements.

5. The apparatus according to claim 4 and wherein the rotor comprises a moving MEMS element, to be driven by the attractive electrostatic force.

6. The apparatus according to claim 1 and also comprising a product, such as a laser beam scanning display for a wearable e.g., smart glasses, wherein said moving element, e.g., tilting mirror, is employed to provide the product's scanning functionality.

7. The apparatus according to claim 1 wherein said moving MEMS element comprises a rotating/tilting MEMS element (e.g., a mirror (e.g., scanning mirror, tilting mirror).

8. The apparatus according to claim 1 wherein said MEMS element/s are driven to travel in-plane.

9. The apparatus according to claim 1 which creates plural forms of motion as a function of voltage patterns applied to the rotor/s and stator/s.

10. The apparatus according to claim 9 wherein the plural forms of motion include all or any subset of: linear motion, step motion, sinusoidal motion.

11. The apparatus according to claim 1 wherein said electrically isolated electrically conductive elements comprise comb sets defining fingers, and wherein said stators comprise fixed comb sets, thereby to provide at least three respective arrays or sets of (typically 70) fixed fingers each.

12. The apparatus according to claim 1 wherein said rotor comprises a comb set, thus providing movable fingers.

13. The apparatus according to claim 1 wherein the stators and rotor/s are arranged in a stack of at least three layers and wherein both a stator and a rotor reside together in one of said layers, thereby to define an improved vertical electrostatic actuator.

14. A microelectromechanical electrostatic actuation method wherein an attractive, aka pulling electrostatic force, acts between electrically isolated electrically conductive elements, thereby to generate motion
wherein the electrically isolated electrically conductive elements comprise:
at least three stators (e.g., if tilting motion rather than linear motion is to be provided) fixed to a substrate such as a MEMS handle layer, and
(at least one) movable rotor (e.g. if tilting motion rather than linear motion is to be provided) which may be connected to a compliant suspension or spring structure and wherein driving voltage introduces electrical potential difference between the stators and/or rotor to yield the attractive electrostatic force which generates said motion by displacing the movable rotor toward the stator/s.

15. The method of claim 14 wherein at least one stator and said rotor are constructed within a single layer and are typically electrically isolated from one another.

16. The method of claim 14 wherein additional stator/s are deployed or constructed or arranged above and/or below said single layer, typically electrically isolated from said rotor and typically electrically isolated from at least one other stator (typically from all of said other stator/s).

17. The apparatus according to claim 13 wherein said stator and said rotor which reside together, reside in/are constructed within a middle layer, which is below a top layer in which at least one of the stators resides/is constructed and above a bottom layer in which at least one of the stators resides/is constructed, thereby to define top, middle, and bottom stators.

18. The apparatus according to claim 17 wherein at least one of the stators includes right and left electrically isolated elements.

19. The apparatus according to claim 17 wherein each of the top, middle, and bottom stators each include right and left stator elements electrically isolated from one another thereby to define six elements all electrically isolated from one another, except that the top stator's right stator element is electrically connected to the bottom stator's left stator element, the top stator's left stator element is electrically connected to the bottom stator's right stator element, and the middle stator's right and left stator elements are electrically connected.

20. The apparatus according to claim 19 wherein the apparatus is used as a vertical electrostatic actuator with rotational motion.

21. The apparatus according to claim 17
wherein each of the top, middle, and bottom stators each include right and left stator elements electrically isolated from one another thereby to define six elements, all electrically isolated from one another, except that:
the top stator's right stator element is electrically connected to the bottom stator's left stator element,
the top stator's left stator element is electrically connected to the bottom stator's right stator element,
the top stator's right stator element is electrically connected to the top stator's left stator element,
the middle stator's right and left stator elements are electrically connected,
the bottom stator's right stator element is electrically connected to the bottom stator's left stator element,
wherein the apparatus is used as a vertical electrostatic actuator with up-down or translation motion.

22. The apparatus according to claim 17 wherein each of the top, middle, and bottom stators each include right and left stator elements electrically isolated from one another thereby to define six elements, all electrically isolated from one another, except that:
the top stator's right and left stator elements are electrically connected and/or
the middle stator's right and left stator elements are electrically connected and/or
the bottom stator's right and left stator elements are electrically connected and wherein the apparatus is used as a horizontal electrostatic actuator.

23. The apparatus according to claim 1 wherein the rotor has a direction of movement and wherein stators from among said at least three stators are arranged on both sides of the direction of movement
and wherein said at least three stators are electrically isolated from one another and typically from the rotor.

24. The apparatus according to claim 1 wherein the stators can be electrically connected to yield rotor translation.

25. The apparatus according to claim 1 wherein the stators can be electrically connected to yield rotor rotation.

26. The apparatus according to claim 1 wherein the electrical connections are per use.

27. The apparatus according to claim 26 wherein the stators can be electrically connected in different ways to yield, e.g., selectably, both translation and rotation of the rotor.
